(19) United States
(12) Patent Application Publication
(10) Pub. No.: US 2008/0200169 A1
(43) Pub. Date: Aug. 21, 2008

(54) METHOD OF SCANNING FOR A NETWORK USING A PREFERRED RADIO ACCESS TECHNOLOGY

(75) Inventor: YAN GAO, BEIJING (CN)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 12/022,428

(22) Filed: Jan. 30, 2008

(30) Foreign Application Priority Data
Feb. 16, 2007 (CN) 200710078950.6

(51) Int. Cl. H04Q 7/20

(52) U.S. Cl. 455/434; 455/574

(57) ABSTRACT

A method of scanning for a network using a preferred radio access technology is useful for improving wireless communication network efficiency and conserving battery power at network nodes. The method includes camping on the network using a current radio access technology, where the current radio access technology is assigned a priority level (step 505). A data set, received from the network, identifying an alternative radio access technology and a priority level assigned to the alternative radio access technology is then processed (step 510). It is then determined whether the alternative radio access technology is a preferred radio access technology by comparing the priority level of the current radio access technology with the priority level of the alternative radio access technology (step 515). If the alternative radio access technology is determined to be a preferred radio access technology, then scanning for the network is performed using the alternative radio access technology (step 520).

### FIELD OF THE INVENTION

The present invention relates generally to wireless communication devices, and in particular to prioritizing radio access technologies to conserve wireless communication network resources.

### BACKGROUND

As different types of communication systems have arisen for mobile telephones, it has become beneficial to provide mobile telephone handsets that are interoperable between various communication systems. Dual-mode mobile telephones therefore have been developed that can operate between two mobile telephone systems. For example, Global System for Mobile (GSM) communication and the Wideband Code Division Multiple Access (WCDMA) communication systems are intended to work together in the same mobile terminal equipment operated under a Universal Mobile Telecommunications System (UMTS) environment, wherein a mobile telephone is required to scan for a home public land mobile network (PLMN) and higher priority PLMNs in these two alternate radio access technologies (RATs), and all possible frequencies within each RAT. In particular, when a UMTS mobile telephone roams and camps on a visited PLMN, the mobile telephone is required to search for its home PLMN and higher priority PLMNs in all frequencies used by these two radio access technologies. In this way, a single mobile telephone can automatically determine the availability of its home PLMN, and thus obtain service on its home PLMN if it is available in a given location. Third generation partnership program (3GPP) specifications allow for a mobile station to perform background scans for PLMNs other than the PLMN on which it has currently obtained service.

GSM and UMTS mobile telephones are required to perform a periodic search for higher priority PLMNs, or their home PLMN (HPLMN), whenever the mobile telephone is camped on a visited PLMN (VPLMN) in their home country. The search is required to be performed periodically at a rate which is specified on a subscriber identity module (SIM) card and is a multiple of six minutes (with the fastest rate being once every six minutes). Such searches consume mobile telephone battery power because a mobile telephone must measure power on all frequencies of all bands which it supports, then synchronize to each frequency on which there is appreciable energy, and then read the PLMN identification of a new cell. For UMTS mobile telephones that support both GSM and WCDMA RATs, 3GPP specifications require the mobile telephones to perform searches in both RATs (i.e., the phone must perform a search for an HPLMN in all radio access technologies that it is capable of using). That is true even if an HPLMN network has cells of only one RAT. Therefore, the requirement to search for all possible frequencies in all possible RATs can waste significant mobile telephone battery power.

### SUMMARY

According to one aspect of the invention there is provided a method of scanning for a network using a preferred radio access technology, the method comprising: camping on the network using a current radio access technology, wherein the current radio access technology is assigned a priority level; processing a data set, received from the network, identifying an alternative radio access technology and a priority level assigned to the alternative radio access technology; determining whether the alternative radio access technology is a preferred radio access technology by comparing the priority level of the current radio access technology with the priority level of the alternative radio access technology; and scanning for the network using the alternative radio access technology if it is determined that the alternative radio access technology is a preferred radio access technology.

### BRIEF DESCRIPTION OF THE FIGURES

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic diagram illustrating an electronic device in the form of a mobile telephone, according to some embodiments of the present invention;

FIG. 2 is a table illustrating a data set that can be received at a mobile telephone in a control channel message from a network, according to some embodiments of the present invention;

FIG. 3 is a list providing a definition of various octets as used in a type field of a data set concerning an alternative radio access technology, according to some embodiments of the present invention;

FIG. 4 is a list providing a definition of various octets as used in a frequency band field concerning an alternative radio access technology, according to some embodiments of the present invention; and

FIG. 5 is a general flow diagram illustrating a method of scanning for a network using a preferred radio access technology, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to scanning for a network using a preferred radio access technology. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, front and back, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device. An element preceded by “comprises a . . . ” does not, without more constraints, preclude the existence of additional identical elements in the process, method, article, or apparatus that comprises the element.

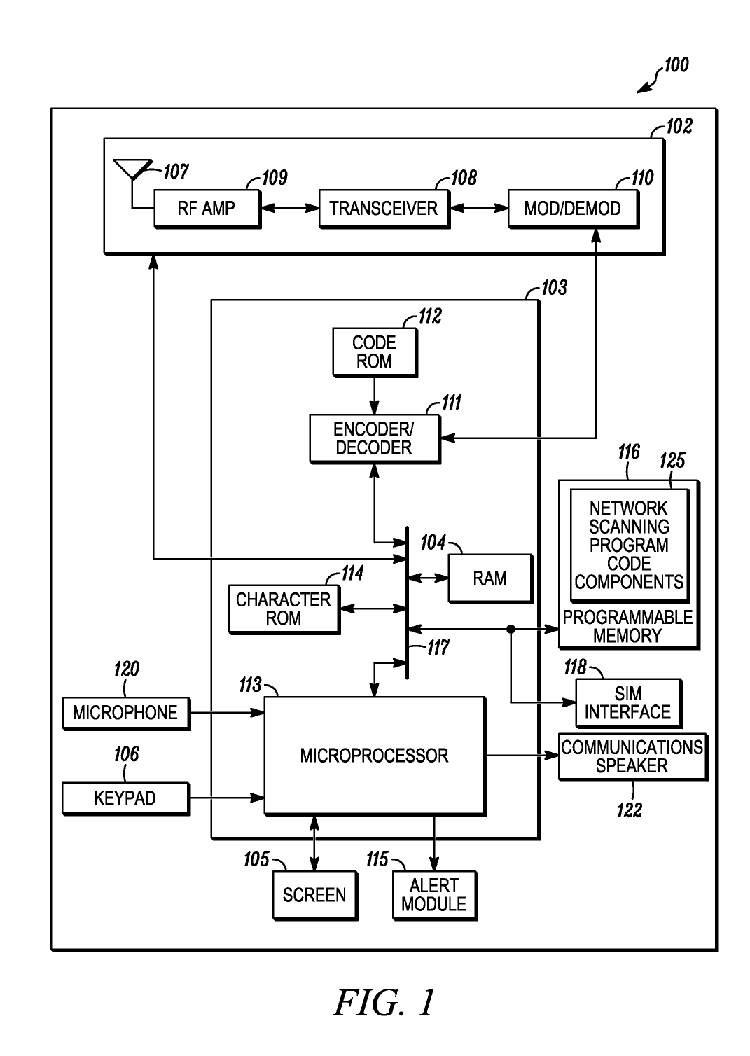

Referring to FIG. 1, a schematic diagram illustrates an electronic device in the form of a mobile telephone 100, according to some embodiments of the present invention. The mobile telephone 100 comprises a radio frequency communications unit 102 coupled to be in communication with a common data and address bus 117 of a processor 103. The mobile telephone 100 also has a keypad 106 and a display screen 105, such as a touch screen coupled to be in communication with the processor 103.

The processor 103 also includes an encoder/decoder 111 with an associated code Read Only Memory (ROM) 112 for storing data for encoding and decoding voice or other signals that may be transmitted or received by the mobile telephone 100. The processor 103 further includes a microprocessor 113 coupled, by the common data and address bus 117, to the encoder/decoder 111, a character Read Only Memory (ROM) 114, a Random Access Memory (RAM) 104, programmable memory 116 and a Subscriber Identity Module (SIM) interface 118. The programmable memory 116 and a SIM operatively coupled to the SIM interface 118 each can store, among other things, a telephone number database (TND) comprising a number field for telephone numbers and a name field for identifiers uniquely associated with the telephone numbers in the number field.

The radio frequency communications unit 102 is a combined receiver and transmitter having a common antenna 107. The radio frequency communications unit 102 has a transceiver 108 coupled to the common antenna 107 via a radio frequency amplifier 109. The transceiver 108 is also coupled to a combined modulator/demodulator 110 that is coupled to the encoder/decoder 111.

The microprocessor 113 has ports for coupling to the keypad 106 and to the display screen 105. The microprocessor 113 further has ports for coupling to an alert module 115 that typically contains an alert speaker, vibrator motor and associated drivers; to a microphone 120; and to a communications speaker 122. The character ROM 114 stores code for decoding or encoding data such as control channel messages that may be transmitted or received by the radio frequency communications unit 102. In some embodiments of the present invention, the character ROM 114, the programmable memory 116, or a SIM also can store operating code (OC) for the microprocessor 113 and code for performing functions associated with the mobile telephone 100. For example, the programmable memory 116 can comprise network scanning program code components 125 configured to cause execution of a method of scanning for a network using a preferred radio access technology (RAT).

Thus some embodiments of the present invention include a method of using the mobile telephone 100 to scan for a network using a preferred radio access technology. The method includes camping on the network using a current radio access technology, where the current radio access technology is assigned a priority level. A data set, received from the network, identifying an alternative radio access technology and a priority level assigned to the alternative radio access technology is then processed. It is then determined whether the alternative radio access technology is a preferred radio access technology by comparing the priority level of the current radio access technology with the priority level of the alternative radio access technology. If the alternative radio access technology is determined to be a preferred radio access technology, then scanning for the network is performed using the alternative radio access technology.

Some embodiments of the present invention thus enable a wireless communication network to transmit periodic control channel messages to the mobile telephone 100 indicating current relative priorities of various alternative radio access technologies. The control channel messages each include a data set that identifies a plurality of alternative radio access technologies and a priority level for each alternative radio access technology. The mobile telephone 100 then scans for the network using one or more of the alternative radio access technologies only if one or more of the alternative radio access technologies is determined to have a higher priority level than a current radio access technology. The mobile telephone 100 therefore is able to conserve battery power, as it is not required to scan for the network unless one of the alternative radio access technologies is determined to have a higher priority level than a current radio access technology. Further, the network can improve network resource management by using the control channel messages to dynamically redirect network devices, such as the mobile telephone 100, away from problematic or congested radio access technologies to preferred alternative radio access technologies.

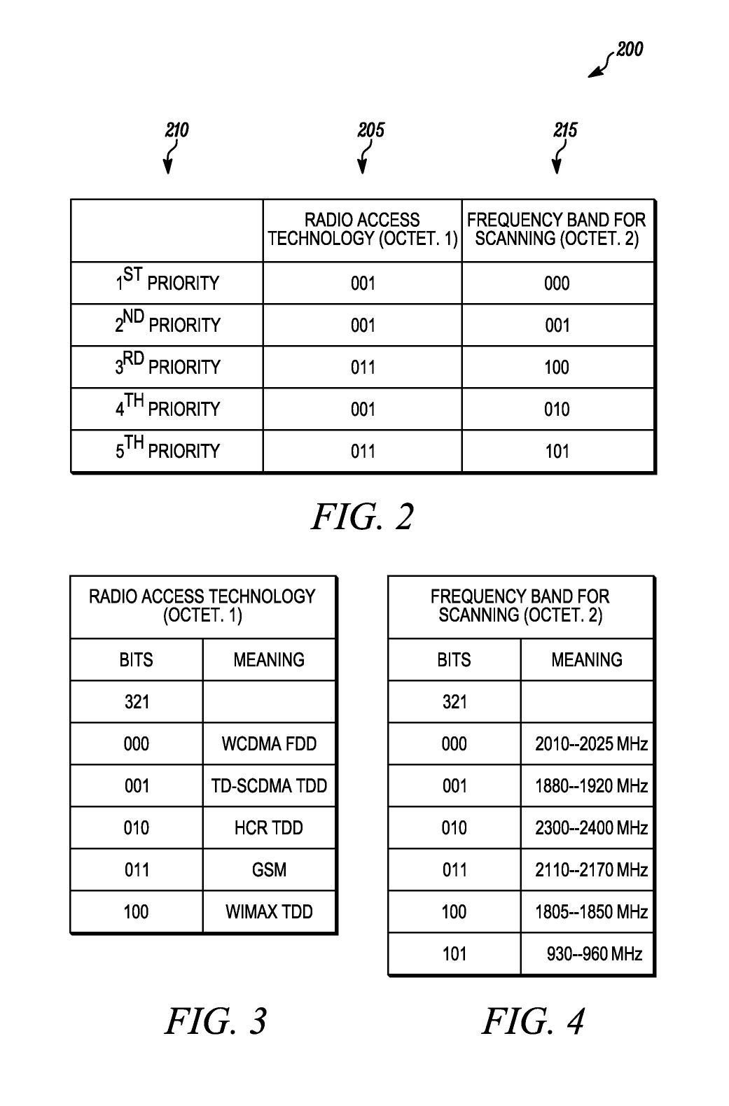

Referring to FIG. 2, a table illustrates a data set 200 that can be received at the mobile telephone 100 in a control channel message from a network, according to some embodiments of the present invention. The data set 200 identifies a type field 205 for a plurality of alternative radio access technologies, a priority level field 210 for each alternative radio access technology, and a frequency band field 215 for each alternative radio access technology. Coded octet bits are used to define the type field 205 and frequency band field 215 of each alternative radio access technology. For example, the coded octet bits “001” in the type field 205 may correspond to a time division synchronous code division multiple access (TD-SCDMA) time division duplex (TDD) type alternative radio access technology, and the coded octet bits “000” in the frequency band field 215 may correspond to a frequency band between 2010 MHz and 2025 MHz.

Referring to FIG. 3, a list provides a definition of various octets as used in the type field 205 concerning alternative radio access technology types, according to some embodiments of the present invention. For example, the octet bits “000” define a wideband code division multiple access (WCDMA) frequency division duplex (FDD) RAT type; the octet bits “001” define a time division synchronous code division multiple access (TD-SCDMA) time division duplex (TDD) RAT type; the octet bits “010” define a high chip rate (HCR) TDD RAT type; the octet bits “011” define a global system for mobile (GSM) communications RAT type; and the octet bits “100” define a worldwide interoperability for microwave access (WiMax) TDD RAT type. As will be understood by those having ordinary skill in the art, various other RAT types also can be described in data sets according to the teachings of the present invention.

Referring to FIG. 4, a list provides a definition of various octets as used in the frequency band field 215 concerning alternative radio access technology types, according to some embodiments of the present invention. For example, the octet bits “000” define a frequency band between 2010 MHz and 2025 MHz; the octet bits “001” define a frequency band between 1880 MHz and 1920 MHz; the octet bits “010” define a frequency band between 2300 MHz and 2400 MHz; the octet bits “011” define a frequency band between 2110 MHz and 2170 MHz; the octet bits “100” define a frequency band between 1805 MHz and 1850 MHz; and the octet bits “101” define a frequency band between 930 MHz and 960 MHz. As will be understood by those having ordinary skill in the art, various other frequency bands also can be described in data sets according to the teachings of the present invention.

According to some embodiments of the present invention, the data set 200 can be provided to the mobile telephone 100 in various ways, including broadcast messages and unicast messages sent over network control channels or other types of network channels. For example, a broadcast control channel allocation (BA) range information element (IE) for a GSM network can include the data set 200 in a channel release message sent to individual radiotelephones, on a phone-by-phone basis, including the mobile telephone 100. Similarly, for a WCDMA RAT, a radio PLMN (RPLMN) IE can include the data set 200 in a radio resource control (RRC) connection release message sent to individual radiotelephones, on a phone-by-phone basis, including the mobile telephone 100. Alternatively, the data set 200 can be broadcast from a network base station (BS) to all mobile stations (MSs) that are camped on a PLMN. For example, the data set 200 can be broadcast in a system information (monitored by all phones), radio access network (RAN), or core network (CN) message.

After receiving the data set 200, the mobile telephone 100 can store the data set 200 in, for example, a Subscriber Identity Module (SIM) operatively coupled to the SIM interface 118, or in the programmable memory 116. Optionally, the mobile telephone 100 can modify the data set 200 to include only those frequencies and RAT types that are supported by the mobile telephone 100.

According to some embodiments of the present invention, scanning for the network is performed using only alternative radio access technologies that have a higher priority level than a priority level of a current radio access technology. Thus the mobile telephone 100 is not required to scan all alternative radio access technologies. Further, the mobile telephone 100 is not required to scan for alternative radio access technologies that have a same priority level as a current radio access technology.

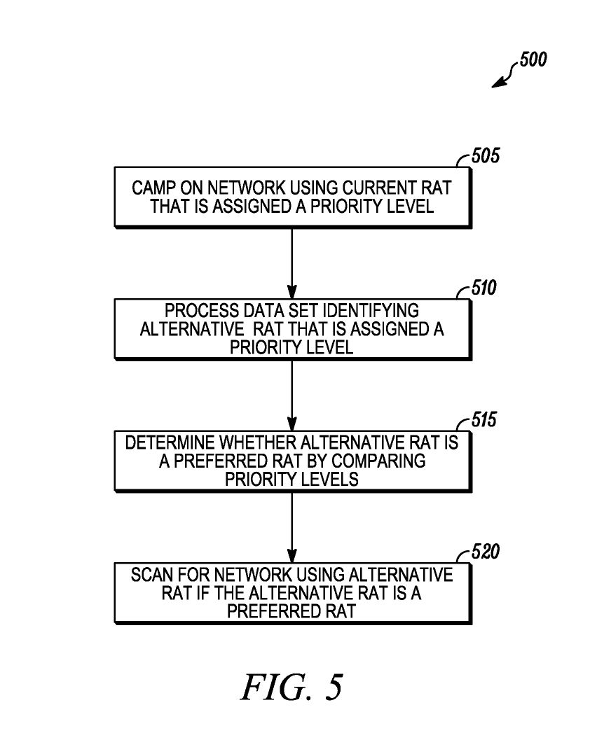

Referring to FIG. 5, a general flow diagram illustrates a method 500 of scanning for a network using a preferred radio access technology, according to some embodiments of the present invention. At step 505, the method 500 is initiated by camping on the network using a current radio access technology, wherein the current radio access technology is assigned a priority level. For example, the mobile telephone 100 camps on a network such as a home public land mobile network (HPLMN) or a visited public land mobile network (VPLMN). Camping is a term well known to those skilled in the art and comprises, for example, an idle mode or inactive, network-connected mode of the mobile telephone 100. The priority level of the current radio access technology can be an arbitrary or relative priority level maintained by the network, and may be communicated to the mobile telephone 100 when the mobile telephone 100 first camps on the network. Alternatively, the priority level of the current radio access technology may not be obtained by the mobile telephone 100 until a data set, such as the data set 200, including descriptions and priority levels of alternative radio access technologies is received at the mobile telephone 100.

At step 510, a data set, received from the network, identifying an alternative radio access technology, a frequency range of the alternative radio access technology and a priority level assigned to the alternative radio access technology is processed. For example, the mobile telephone 100 can receive the data set 200 as a control channel message broadcast (a broadcast message) from an HPLMN on which the mobile telephone 100 is camped. The data set 200 then can be stored in the programmable memory 116 and processed using the microprocessor 113. The data set 200 can be received as a periodic update from the network based on current network operating conditions, and can thus replace a previous data set stored in the mobile telephone 100, which previous data set was based on previous network operating conditions.

At step 515, it is determined whether the alternative radio access technology is a preferred radio access technology by comparing the priority level of the current radio access technology with the priority level of the alternative radio access technology. For example, consider that the mobile telephone 100 has processed the data set 200 and is camped on a network using a current RAT that is a GSM RAT within a frequency band of 1805 MHz to 1850 MHz. The RAT type field 205, the priority level field 210, and the frequency band field 215 of the data set 200, in conjunction with the definitions provided in FIG. 3 and FIG. 4, therefore identify the current RAT as having a third priority level relative to the other RATs identified in the data set 200. Therefore, by comparing the priority levels in the priority level field 210, the mobile telephone 100 determines that the first priority RAT in the data set 200, which is a TD-SCDMA TDD RAT in the frequency band between 2010 MHz and 2025 MHz, is a preferred radio access technology. The mobile telephone 100 also determines that the second priority RAT in the data set 200, which is a TD-SCDMA TDD RAT in the frequency band between 1880 MHz and 1920 MHz, is also a preferred radio access technology.

At step 520, scanning for the network is performed using the alternative radio access technology if it is determined that the alternative radio access technology is a preferred radio access technology. For example, consider that the mobile telephone 100 has determined that the alternative radio access technology identified in the data set 200 as a first priority RAT is a preferred RAT relative to a current radio access technology, such as the RAT in the data set 200 identified as having a third priority. The mobile telephone 100 will therefore scan the network using the preferred RAT, which in the present example means scanning for the network using a TD-SCDMA TDD RAT in the frequency band between 2010 MHz and 2025 MHz. The mobile telephone 100 may first check that it is capable of operating in such a preferred RAT, and may also scan the network using other alternative radio access technologies that are determined to be preferred radio access technologies. For example, the mobile telephone 100 may also scan for the network using the second priority RAT identified in the data set 200.

Advantages of some embodiments of the present invention therefore include improved efficiency in wireless communication networks. Network operators are able to dynamically define relative priority levels for various radio access technology types and frequency bands. As network conditions change, including for example changes in a total number of attached subscribers, congestion, or performance of particular RATs, network operators are able to redefine and update such relative priority levels and report such changes to network nodes. As described in detail above, such reporting can be performed using data sets transmitted in control channel messages or using other means. Network nodes, such as the mobile telephone 100, are then able to switch to a preferred radio access technology based on the redefined and updated relative priority levels. Further, network nodes are able to conserver battery power by scanning for a network using only a radio access technology that is first determined to be a preferred radio access technology relative to a current radio access technology.

It will be appreciated that embodiments of the invention described herein may be comprised of one or more conventional processors and unique stored program instructions that control the one or more processors to implement, in conjunction with certain non-processor circuits, some, most, or all of the functions of scanning for a network using a preferred radio access technology as described herein. The non-processor circuits may include, but are not limited to, a radio receiver, a radio transmitter, signal drivers, clock circuits, power source circuits, and user input devices. As such, these functions may be interpreted as steps of a method of scanning for a network using a preferred radio access technology. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims.

We claim:

1. A method of scanning for a network using a preferred radio access technology, the method comprising:
camping on the network using a current radio access technology, wherein the current radio access technology is assigned a priority level;
processing a data set, received from the network, identifying an alternative radio access technology and a priority level assigned to the alternative radio access technology;
determining whether the alternative radio access technology is a preferred radio access technology by comparing the priority level of the current radio access technology with the priority level of the alternative radio access technology; and
scanning for the network using the alternative radio access technology if it is determined that the alternative radio access technology is a preferred radio access technology.

2. The method of claim 1, wherein the data set identifying the alternative radio access technology identifies a plurality of alternative radio access technologies and a priority level for each alternative radio access technology.

3. The method of claim 1, wherein the set identifying the alternative radio access technology identifies a type of the alternative radio access technology, a frequency range of the alternative radio access technology, and the priority level of the alternative radio access technology.

4. The method of claim 2, wherein scanning for the network is performed using only alternative radio access technologies that have a higher priority level than the priority level of the current radio access technology.

5. The method of claim 1, wherein the set identifying the alternative radio access technology is received from the network as a broadcast message.

6. The method of claim 1, wherein the set identifying the alternative radio access technology is received from the network as a control channel message.

7. The method of claim 2, wherein the plurality of alternative radio access technologies comprise time division duplex technologies or frequency division duplex technologies.

8. The method of claim 2, wherein the plurality of alternative radio access technologies comprise code division multiple access technologies, global system for mobile communications technologies, high chip rate technologies, or worldwide interoperability for microwave access technologies.

9. The method of claim 1, wherein the network is a public land mobile network.

10. The method of claim 1, wherein the data set is received as a periodic update from the network and is based on current network operating conditions.
